(19) United States
(12) Patent Application Publication
(10) Pub. No.: US 2025/0309749 A1
(43) Pub. Date: Oct. 2, 2025

(54) ZVS CONTROL CIRCUIT AND CONTROL METHOD FOR RESONANT FLYBACK POWER CONVERTER

(71) Applicant: Richtek Technology Corporation, Zhubei City (TW)

(72) Inventors: Ta-Yung Yang, Taoyuan (TW); Kun-Yu Lin, Hsinchu (TW); Fu-Ciao Syu, New Taipei (TW); Chia-Hsien Yang, Keelung (TW); Tzu-Chen Lin, Hsinchu (TW)

(21) Appl. No.: 18/827,715

(22) Filed: Sep. 7, 2024

Related U.S. Application Data
(60) Provisional application No. 63/570,867, filed on Mar. 28, 2024.

(51) Int. Cl. H02M 1/00; H02M 3/00; H02M 3/335

(52) U.S. Cl. CPC H02M 1/0058; H02M 3/01; H02M 3/33592

(57) ABSTRACT

A control circuit for a resonant flyback power converter includes high-side and low-side signals to control respective high-side and low-side transistors. It uses a negative current signal from an auxiliary winding related to its cross-voltage. The circuit generates a threshold and a sensing signal based on the activation and deactivation of the high-side and low-side transistors respectively, and a triggering signal by comparing the sensing signal with the threshold. The high-side and low-side transistors switch a primary winding through a resonant capacitor, generating an output voltage through a secondary winding. The pulse width of the low-side signal is adjusted based on the triggering signal to achieve zero voltage switching (ZVS) of the high-side transistor.

CROSS REFERENCE

The present invention claims priority to U.S. 63/570867 filed on Mar. 28, 2024.

### BACKGROUND OF THE INVENTION

### Field of Invention

The present invention relates to a ZVS control circuit. Particularly it relates to a ZVS control circuit for controlling a resonant flyback power converter. The present invention also relates to a control method for controlling the above resonant flyback power converter.

### Description of Related Art

The resonant flyback power converter is a high-efficiency power converter. Its wide-range output voltage capability offers advantages for use in USB Type-C power supplies and power adapters, especially for USB PD EPR (Extended Power Range) converters. Recent developments in energy-saving regulations require that power converters operate with high efficiency under heavy loads, as well as to maintain high efficiency in light load conditions.

The high-efficiency performance of the resonant flyback power converter is attributed to its resonant and ZVS (Zero Voltage Switching) operations. However, conventional resonant flyback power converters typically incur higher power loss to achieve ZVS, making it challenging to conserve power during light load operations.

In view of the above, to overcome the drawbacks of prior art, the present invention provides a control method and control circuit that address this issue, achieving high-efficiency ZVS operation for both heavy and light load conditions.

### SUMMARY OF THE INVENTION

From one perspective, the present invention provides a control circuit for controlling a resonant flyback power converter, wherein the control circuit comprises a high-side signal to control a high-side transistor, a low-side signal to control a low-side transistor, a negative current signal generated by an auxiliary winding of a transformer, wherein the negative current signal is related to a cross-voltage of the auxiliary winding, a first signal generated by the negative current signal in response to the activation of the high-side transistor, a second signal generated by the negative current signal in response to the deactivation of the low-side transistor when the high-side transistor is off, and a third signal generated by comparing the second signal with a voltage threshold, wherein the voltage threshold is related to the level of the first signal, wherein through a resonant capacitor, the high-side and low-side transistors are configured to switch a primary winding of the transformer, generating an output voltage through a secondary winding of the transformer, wherein a pulse width of the low-side signal is adjusted based on the third signal to achieve zero voltage switching (ZVS) of the high-side transistor.

In one embodiment, the high-side signal activates the high-side transistor through a level-shift buffer once the level of the second signal exceeds the voltage threshold.

In one embodiment, the control circuit further comprises a sample-hold circuit configured to generate the first signal by sampling an I-to-V signal, wherein the I-to-V signal is generated by the negative current signal, and wherein the level of the first signal correlates with an input voltage level of the transformer.

In one embodiment, the control circuit further comprises an up-down counter to adjust the pulse width of the low-side signal based on the first signal and the second signal.

In one embodiment, the control circuit is further configured to regulate an off-period to be equal to predetermined target period by adjusting the pulse width of the low-side signal, wherein the off-period is a duration from the deactivation of the low-side signal to a subsequent activation of the high-side signal.

In one embodiment, the control circuit further comprises a period reference signal generated based on the predetermined target period and an off-period signal generated based on the off-period, wherein a level of the off-period signal is regulated to be aligned with a level of the period reference signal by adjusting the pulse width of the low-side signal, thereby aligning the off-period with the predetermined target period.

In one embodiment, when the off-period is determined to be longer than the predetermined target period, the pulse width of the low-side signal is increased, and when the off-period is determined to be shorter than the predetermined target period, the pulse width of the low-side signal is decreased.

In one embodiment, the voltage threshold includes an upper threshold and a lower threshold, wherein the off-period is regulated only when the second signal is between the upper threshold and the lower threshold.

In one embodiment, the predetermined target period correlates with an optimized circulating current generated by the low-side transistor, such that the cross-voltage of the high-side transistor is sufficiently low for ZVS while the circulating current remains sufficiently low to achieve a target conversion efficiency.

In one embodiment, the control circuit further comprises a maximum off-period signal to limit the off-period no longer than a corresponding maximum off-period.

In one embodiment, the active period of the low-side signal equals or exceeds a demagnetization time of the transformer.

In one embodiment, the control circuit further comprises a volt-second circuit to generate the low-side signal based on the active time of the high-side signal, an input voltage level of the transformer, and the output voltage level of the converter.

In one embodiment, activating the low-side transistor generates a circulating current following the demagnetization of the transformer, wherein the circulating current is configured to achieve ZVS of the high-side transistor, and is constituted by a negative magnetizing current of the transformer.

In one embodiment, when the level of the second signal is lower than the voltage threshold, the pulse width of the low-side signal is increased, wherein when the level of the second signal is higher than the voltage threshold, the pulse width of the low-side signal is decreased.

In one embodiment, the voltage threshold includes an upper threshold and a lower threshold, wherein the upper threshold is higher than the lower threshold, wherein when the level of the second signal is lower than the lower threshold, the pulse width of the low-side signal is increased, wherein when the level of the second signal is higher than the upper threshold, the pulse width of the low-side signal is decreased.

In one embodiment, the control circuit further comprises a delay circuit configured to activate the high-side transistor through the level-shift buffer only after providing a delay time once the level of the second signal exceeds the voltage threshold.

From another perspective, the present invention provides a control circuit for controlling a resonant flyback power converter, wherein the control circuit comprises a high-side signal to control a high-side transistor and a low-side signal to control a low-side transistor, wherein through a resonant capacitor, the high-side and low-side transistors are configured to switch a primary winding of the transformer, generating an output voltage through a secondary winding of the transformer, wherein an off-period is regulated to be equal to a predetermined target period by adjusting a pulse width of the low-side signal to achieve zero voltage switching (ZVS) of the high-side transistor, wherein the off-period is a duration from the deactivation of the low-side signal to a subsequent activation of the high-side signal.

From another perspective, the present invention provides a control method for controlling a resonant flyback power converter, wherein the control method comprises: generating a high-side signal to control a high-side transistor, generating a low-side signal to control a low-side transistor, generating a negative current signal related to a voltage across an auxiliary winding of a transformer, generating a threshold generated by the negative current signal in response to the activation of the high-side transistor, after deactivation of the low-side transistor, activating the high-side signal once the negative current signal exceeds the threshold, switching a primary winding of the transformer through a resonant capacitor by the high-side transistor and the low-side transistor, thereby generating an output voltage through a secondary winding of the transformer, and adjusting a pulse width of the low-side signal to achieve zero voltage switching (ZVS) of subsequent activation of the high-side transistor according to a comparison between the negative current signal and the threshold.

In one embodiment, the control method further comprises regulating an off-period to be equal to a predetermined target period by adjusting the pulse width of the low-side signal, wherein the off-period is a duration from the deactivation of the low-side signal to a subsequent activation of the high-side signal.

In one embodiment, the voltage threshold includes an upper threshold and a lower threshold, wherein the step of regulating the off-period further includes regulating the off-period only when the second signal is between the upper threshold and the lower threshold.

In one embodiment, the step of regulating the off-period further includes configuring the predetermined target period to be correlated with an optimized circulating current generated by the low-side transistor, such that the cross-voltage of the high-side transistor is sufficiently low for ZVS while the circulating current remains sufficiently low to achieve a target conversion efficiency.

In one embodiment, the control method further comprises limiting the off-period no longer than a maximum off-period.

In one embodiment, the active period of the low-side signal equals or exceeds a demagnetization time of the transformer.

From another perspective, the present invention provides a control method for controlling a resonant flyback power converter, wherein the control method comprises: generating a high-side signal to control a high-side transistor, generating a low-side signal to control a low-side transistor, switching a primary winding of the transformer through a resonant capacitor by the high-side transistor and the low-side transistor, thereby generating an output voltage through a secondary winding of the transformer, and regulating an off-period to be equal to a predetermined target period by adjusting a pulse width of the low-side signal to achieve zero voltage switching (ZVS) of the high-side transistor, wherein the off-period is a duration from the deactivation of the low-side signal to a subsequent activation of the high-side signal.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a circuit diagram of a resonant flyback power converter, namely, an asymmetrical half-bridge (AHB) resonant flyback power converter, according to a preferred embodiment of the present invention.

FIG. 2 shows operating waveforms corresponding to the embodiment presented in FIG. 1.

FIG. 3 is a preferred embodiment of the control circuit according to the present invention.

FIG. 4 illustrates a preferred circuit for generating the high-side signal.

FIG. 5 illustrates a preferred embodiment of a volt-second circuit according to the present invention.

FIG. 6 illustrates a preferred circuit for generating the low-side signal according to the present invention.

FIG. 7 depicts the waveforms for the circuits shown in FIG. 5 and FIG. 6.

FIG. 8 illustrates a preferred circuit for generating the adjustable current according to the present invention.

FIG. 9 illustrates another preferred circuit for generating the low-side signal and half-bridge circuit according to the present invention.

FIG. 10 depicts waveforms operating in DCM according to an embodiment of the present invention.

FIG. 11 depicts waveforms operating in asynchronous DCM according to an embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

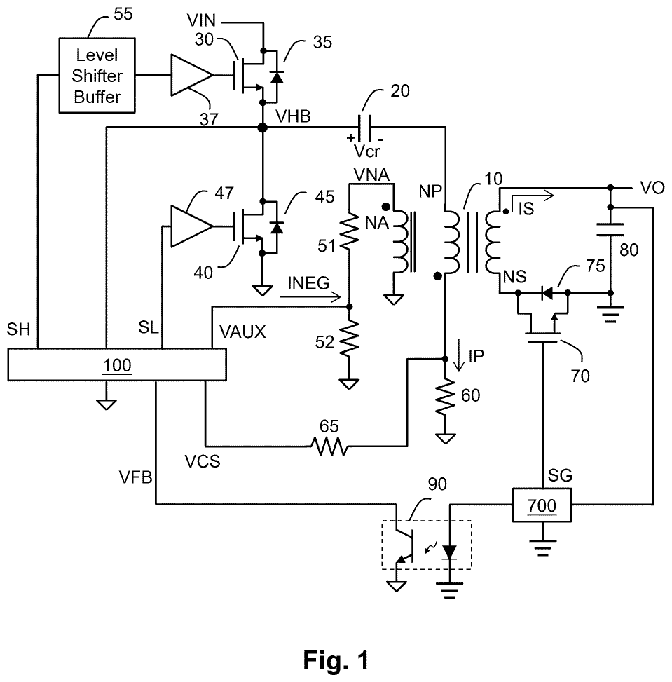

FIG. 1 shows a circuit diagram of a resonant flyback power converter, namely, an asymmetrical half-bridge (AHB) resonant flyback power converter, according to a preferred embodiment of the present invention. The resonant flyback power converter includes a half-bridge circuit, a transformer 10, a resonant capacitor 20, and a primary control circuit 100.

The half-bridge circuit comprises a high-side transistor 30 and a low-side transistor 40, which are connected in series between the input voltage VIN and ground. The resonant capacitor 20 and the transformer 10 are connected in series. The high-side transistor 30 and the low-side transistor 40 are both connected to a switching node VHB. The transformer 10 includes a primary winding NP, a secondary winding NS, and an auxiliary winding NA.

The primary control circuit 100 is configured to generate a high-side signal SH and a low-side signal SL, which are fed into the half-bridge circuit to control the transformer 10 in generating the output voltage VO at the secondary winding NS of the transformer 10. The primary control circuit 100 generates the high-side signal SH configured to turn on the high-side transistor 30 through a level-shift buffer 55 to magnetize the primary winding NP of the transformer 10. After turning off the high-side transistor 30, the primary control circuit 100 generates the low-side signal SL to turn on the low-side transistor 40.

The magnetizing energy from the operation of magnetic induction is transferred to the secondary winding NS of the transformer 10 through the resonant capacitor 20 and the primary winding NP in a resonant operation, generating the output voltage VO. The period of the low-side signal SL corresponds to the demagnetizing period of the transformer 10, and the pulse width of the low-side signal SL is set to be equal to or longer than the demagnetizing period of the transformer 10.

A resistor 60 is configured to detect a primary-side switching current IP, creating a current-sense signal VCS. In one embodiment, the primary control circuit 100 generates the high-side signal SH based on a feedback signal VFB, which is generated according to the output voltage VO of the resonant flyback power converter. In this embodiment, a secondary control circuit 700, connected to the output voltage VO, generates the feedback signal VFB based on the output voltage VO. In one version, the feedback signal VFB is sent to the primary control circuit 100 through an opto-coupler 90. The secondary control circuit 700 is also designed to generate a driving signal SG for controlling a synchronous rectification switch 70 during the demagnetizing period of the transformer 10. The auxiliary winding NA generates an auxiliary winding signal VNA. Resistors 51 and 52 are configured, as a voltage divider, to divide the auxiliary winding signal VNA to generate an auxiliary winding-related signal VAUX.

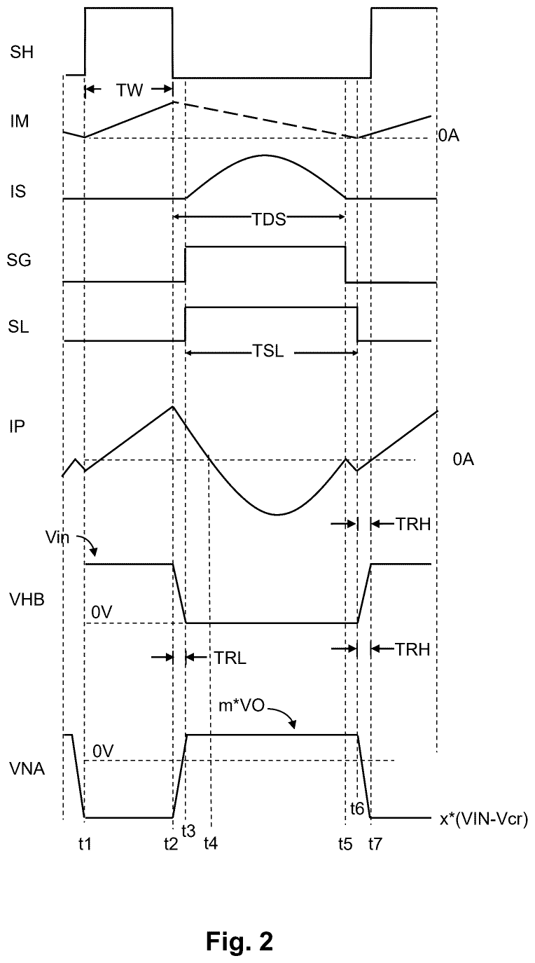

FIG. 2 shows operating waveforms corresponding to the embodiment presented in FIG. 1. The transformer 10 becomes magnetized, generating a magnetizing current IM when the high-side signal SH is turned on. The transformer 10 demagnetizes upon the deactivation of the high-side signal SH. During this demagnetizing period TDS, the transformer 10 generates a secondary switching current IS. The period of the low-side signal SL corresponds to the demagnetizing period TDS of the transformer 10. In one embodiment, the period TSL (i.e., the pulse width) of the low-side signal SL is set to be equal to or longer than the demagnetizing period TDS of the transformer 10. A voltage Vcr is induced in the resonant capacitor 20 during the demagnetizing period TDS of the transformer 10, where Vcr=n*VO and n represents the turn ratio of the primary winding NP to the secondary winding NS.

The low-side signal SL can be activated following the deactivation of the high-side signal SH, and vice versa. Dead-time periods, such as TRH and TRL, are included between the high-side signal SH and the low-side signal SL.

The operations during various time intervals in FIG. 2 are explained as follows: The period from t1 to t2 represents a magnetized transformer cycle, where the high-side transistor 30 is on, and the low-side transistor 40 is off. The current IP in the transformer 10 and the voltage in the resonant capacitor 20 increase. The transformer 10 magnetizes, and the resonant capacitor 20 charges. The secondary synchronous rectifier 70 is off, and its body diode 75 is inversely biased, preventing energy transfer to the secondary side.

The period from t2 to t3 denotes a first circulating current cycle, with both the high-side transistor 30 and the low-side transistor 40 off. The circulating current in the transformer 10 causes the switching node voltage VHB of the half-bridge circuit to drop until the body diode 45 of the low-side transistor 40 turns on. The interval from t2 to t3 is a quasi-resonant period crucial for achieving ZVS of the low-side transistor 40. At t3, the primary side of the transformer 10 attains the same voltage as the resonant capacitor 20.

The period from t3 to t4 represents a resonant cycle (positive current). The high-side transistor 30 is off, and the low-side transistor 40 is turned on under ZVS condition. The output voltage VO equals the voltage Vcr across the resonant capacitor 20, divided by the turn ratio n. The current begins flowing through the secondary synchronous rectifier 70, transferring the energy stored in the transformer 10 to generate the output voltage VO. As the LC resonant tank is formed by the leakage inductance Lr of the transformer 10 and the resonant capacitor 20 (Cr), the secondary current follows a sinusoidal pattern with a period determined by the resonant frequency of Lr and Cr. The primary side current of the transformer 10 comprises the magnetizing current IM plus the reflected secondary current IS. The resonant tank current (Lr, Cr) remains positive, predominantly driven by the magnetizing inductance of the transformer 10, flowing into the resonant capacitor 20.

The period from t4 to t5 represents a resonant cycle (negative current). The high-side transistor 30 remains off, and the low-side transistor 40 continues to be on. Energy transfer to the secondary side continues, but the resonant tank current is now inversely driven by the voltage in the resonant capacitor 20. Energy of the resonant capacitor 20 energy is not only transferred to the secondary side but also used to bring the magnetizing current of the transformer 10 to a negative level while the low-side transistor 40 is continuously on (e.g., t4 to t5).

The period from t5 to t6 denotes a backward magnetized transformer cycle (negative current). This cycle begins at the end of the demagnetizing period TDS of the transformer 10 and lasts until the low-side transistor 40 is turned off. The resonant capacitor 20 inversely magnetizes the transformer 10, generating a negative current.

The period from t6 to t7 signifies a second circulating current cycle. Both the high-side transistor 30 and the low-side transistor 40 are off. The negative current induced in the transformer 10 from t5 to t6 causes the voltage VHB at the switching node of the half-bridge circuit to rise, eventually turning on the body diode 35 of the high-side transistor 30.

After the time point t7, another cycle similar to t1 to t2 starts, where the high-side transistor 30 is turned on under ZVS condition, and the low-side transistor 40 is off. If the circulated current in the transformer resonant tank is still negative, any excess energy in the resonant tank will be sent back to the input voltage VIN.

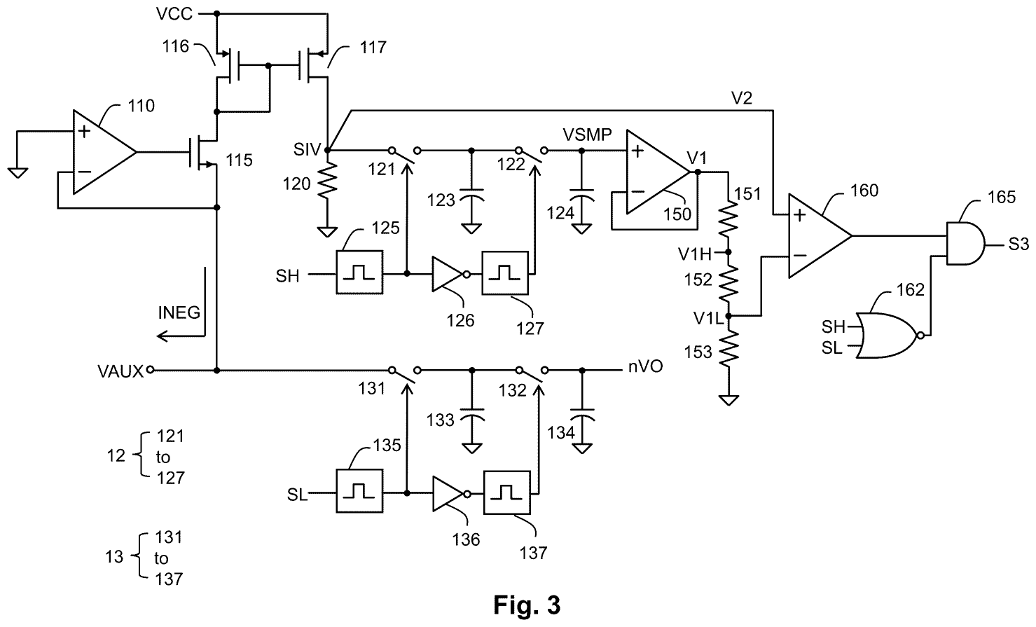

FIG. 3 is a preferred embodiment of the control circuit according to the present invention. A negative current signal INEG is generated via the auxiliary winding NA of the transformer 10 during the periods t1-t2 and t6-t7 (as shown in FIG. 2). A first signal V1 is generated by the negative current signal INEG in response to the activation of the high-side transistor 30. A first sample-hold circuit 12 is configured to generate the first signal V1 by sampling an I-to-V signal SIV while the high-side signal SH is on. The I-to-V signal SIV is generated from the negative current signal INEG by a current-to-voltage circuit. The level of the first signal V1 correlates with an input voltage level of the transformer 10 (i.e., VIN-Vcr, the voltage across the primary winding). An operational amplifier 110, transistors 115, 116, 117, and resistor 120 form the current-to-voltage circuit. Switches 121, 122, capacitors 123, 124, and pulse-generators 125, 127 form the first sample-hold circuit 12.

A second signal V2 is generated by the negative current signal INEG in response to the deactivation of the low-side transistor 40 when the high-side transistor 30 is off. A third signal S3 is generated by comparing the second signal V2 with a voltage threshold V1L. The enabling of the third signal S3 (e.g., when the second signal V2 exceeds the voltage threshold V1L) indicates that the cross-voltage of the high-side transistor 30 decreases, due to the negative circulating current, to an extent that it will achieve ZVS of the high-side transistor 30 at the activation of the high-side signal SH. Both voltage thresholds V1H and V1L are generated based on the first signal V1 through a voltage buffer 150 and a resistor divider composed of resistors 151, 152, 153. The voltage thresholds V1H and V1L is proportional to the level of the first signal V1. The pulse width of the low-side signal SL is adjusted based on the third signal S3 to achieve ZVS of the high-side transistor 30.

A second sample-hold circuit 13 is coupled to the auxiliary winding NA of the transformer 10 to generate a reflected-output voltage nVO in response to the activation of the low-side transistor 40 (during the period t4-t5). The level of the reflected-output voltage nVO correlates with the output voltage VO of the power converter when the low-side transistor 40 is on. Switches 131, 132, capacitors 133, 134, and pulse-generators 135, 137 form the second sample-hold circuit 13.

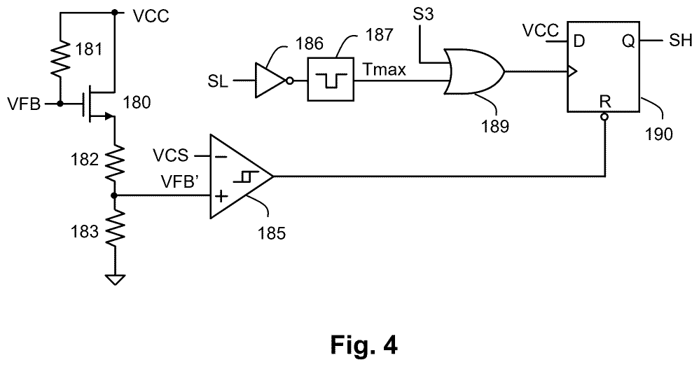

FIG. 4 illustrates a preferred circuit for generating the high-side signal SH. On one hand, the high-side signal SH is generated in response to the feedback signal VFB and the current-sense signal VCS. More specifically, the comparator 185 is configured to compare the feedback signal VFB′ and the current-sense signal VCS to control the duty of the high-side signal SH. In this embodiment, the feedback signal VFB′ is proportional to the feedback signal VFB, which is achieved by a buffer and divider circuit formed by a transistor 180, resistors 181, 182 and 183.

On the other hand, the high-side signal SH is further determined in response to the third signal S3. With a sufficient negative circulating current, S3 will be activated, indicating the voltage across the high-side transistor 30 is low enough for ZVS, to trigger the turning on of the high-side signal SH.

In conditions where the negative circulating current is not sufficient for ZVS (not able to activate S3), a time-out mechanism is required. A pulse generator 187 generates a maximum off-period signal Tmax, which determines the longest permissible duration between the deactivation of the low-side signal SL and the subsequent activation of the high-side signal SH.

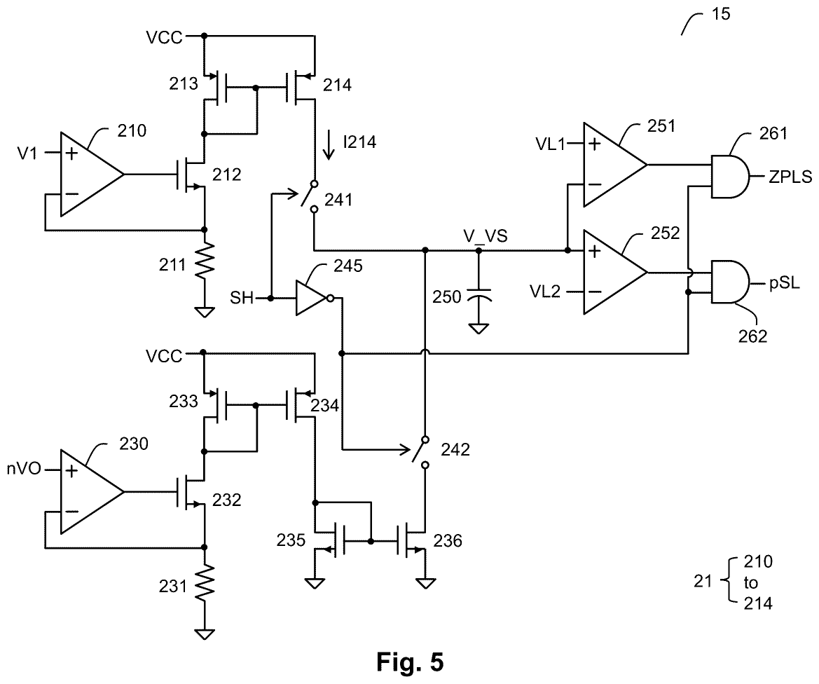

FIG. 5 illustrates a preferred embodiment of a volt-second circuit according to the present invention. This volt-second circuit 15 generates the low-side signal SL based on the active time of the high-side signal SH, the input voltage level (VIN-Vcr) of the transformer 10, and the output voltage VO of the power converter. The voltage level of the first signal V1 is related to the voltage level of (VIN-Vcr). A voltage-to-current circuit 21 is configured to generate a charge current I214 based on the first signal V1. The voltage-to-current circuit 290 includes a buffer circuit formed by an amplifier 201, a transistor 212 and a feedback resistor 211, and a current mirror formed by transistors 213 and 214. The charge current I214 is configured to charge a capacitor 250 via a switch 241. This switch 241 is activated to charge the capacitor 250 during the active period of the high-side signal SH.

On the other hand, the reflected-output voltage nVO is referenced to generate a discharge current in a similar manner by a voltage-to-current circuit 21, discharging the capacitor 250 through a switch 242. This switch 242 is activated for discharging the capacitor 250 when the high-side signal SH is deactivated. A voltage signal V_VS, emulating the magnetizing current and demagnetizing current of the transformer 10, is thereby created across the capacitor 250.

A pre-low-side signal pSL is enabled when the high-side signal SH is off and is disabled once V_VS drops below a threshold VL2. The pre-low-side signal pSL, used to generate the low-side signal SL, has a pulse width related to the demagnetizing time of the transformer 10.

During the deactivation period of the high-side signal SH, a trigger signal ZPLS is generated when the level of V_VS falls below a threshold VL1. The trigger signal ZPLS is used to trigger a ZVS pulse signal SZVS. In the present invention, the pulse width of the ZVS pulse signal SZVS (i.e., the ZVS pulse signal SZVS) can be adaptively tuned to an optimal time length to achieve ZVS for the high-side transistor 30 for the subsequent turning-on while without causing the circulation current too high, which will be explained in detail hereafter.

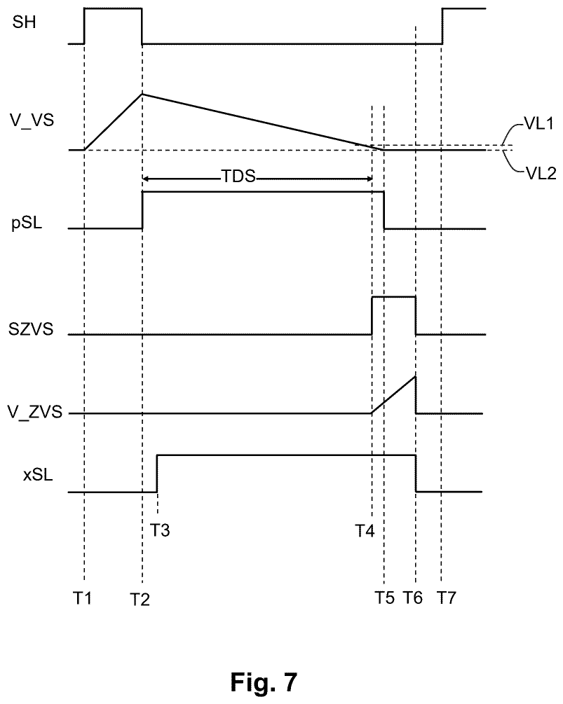

Referring to FIG. 5 and FIG. 7 which depicts the operating waveforms corresponding to FIG. 5. When the resonant flyback power converter is operating in BCM (boundary conduction mode), the threshold level of VL1 is set higher than that of VL2, causing the demagnetizing period and the ZVS pulse period to overlap, forming a single pulse of the low-side signal SL.

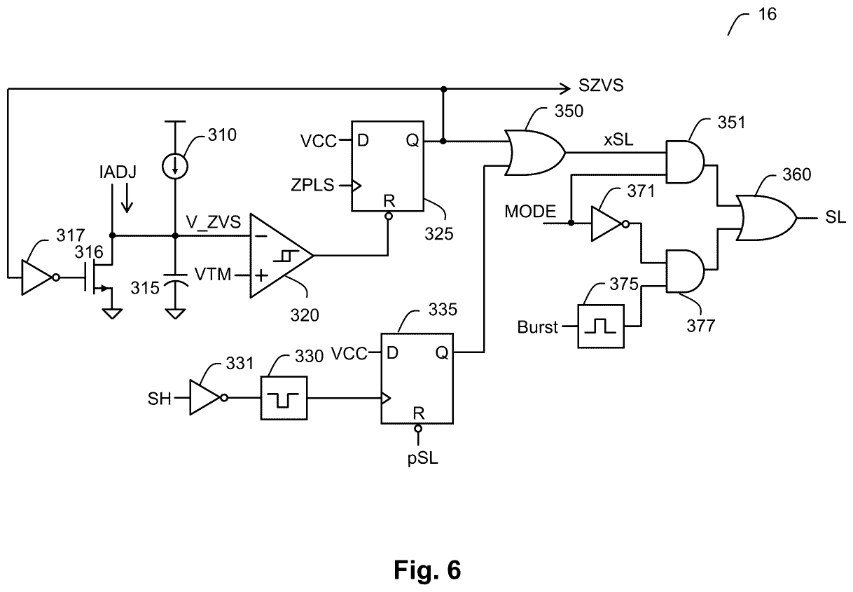

FIG. 6 illustrates a preferred ZVS timer circuit 16 in conjunction with a logic circuit for generating the low-side signal SL based on the trigger signal ZPLS and the pre-low-side signal pSL. A flip-flop 335 is set by a pulse generator 330 when the high-side signal SH deactivates. The pre-low-side signal pSL is configured to reset flip-flop 335. The output of flip-flop 335 is used to generate the low-side signal SL through OR gates 350, 360, and an AND gate 351. The pulse width of the signal from pulse generator 330 determines the period t2-t3 (shown in FIG. 2), which is essential for achieving ZVS for the low-side transistor 40.

Besides the demagnetizing time of the transformer 10, the low-side signal SL includes a ZVS pulse signal SZVS generated by the ZVS timer circuit formed by a flip-flop 325, a comparator 320, a capacitor 315, a current source 310, an adjustable current IADJ, and a switch 316. Flip-flop 325 is set by the trigger signal ZPLS and reset by the comparator 320 once the voltage signal V_ZVS exceeds the threshold VTM. The current source 310, along with the adjustable current IADJ, charges capacitor 315 to generate the voltage signal V_ZVS in response to the ZVS pulse signal SZVS. The adjustable current IADJ is used to tune the pulse width of the ZVS pulse signal SZVS, and consequently, the pulse width of the low-side signal SL, optimizing the ZVS performance (during the period of t6-t7) for the high-side transistor 30. A shorter duration of the low-side signal SL (the ZVS pulse signal SZVS) may result in a lower circulating current, potentially insufficient for proper ZVS. In contrast, a longer duration can achieve ZVS but might lead to higher power losses due to higher circulation current. An optimal circulating current generated by the control circuit can ensure both ZVS and enhanced power efficiency, especially under light load conditions.

Note that in the aforementioned embodiment shown in FIG. 6, the pulse width of the low-side signal SL is tuned by adjusting the integration current through IADJ. However, in other embodiments, the pulse width of the low-side signal SL can be alternatively tuned by adjusting the capacitance of the capacitor 315 or by adjusting the threshold VTM.

During light load and burst mode operations, with the MODE signal set to 0, the low-side signal SL is triggered by the Burst signal and generated solely by a ZVS pulse signal from pulse generator 375.

FIG. 7 depicts the waveforms for the circuits shown in FIG. 5 and FIG. 6 corresponding to operation in BCM. The period T1-T2 represents the turn-on period of the high-side signal SH and is related to the magnetizing period of the transformer 10. The period T2-T5 is the enable period of the pre-low-side signal pSL, which is related to the demagnetizing period TDS of the transformer 10. The period T2-T3 provides a dead-time during which both the high-side transistor 30 and the low-side transistor 40 are off, achieving ZVS when subsequently turning on the low-side transistor 40. Similarly, the period T6-T7 provides a dead-time for both the high-side transistor 30 and the low-side transistor 40, achieving ZVS when subsequently turning on the high-side transistor 30. Excluding the dead-time of T2-T3, the low-side signal xSL, a single pulse, includes the periods of the pre-low-side signal pSL and the ZVS pulse signal SZVS. The period T4-T6 (ZVS pulse width), which is the period of the ZVS pulse signal SZVS, is an adjustable period for generating optimal circulating current to achieve ZVS of the high-side transistor 30.

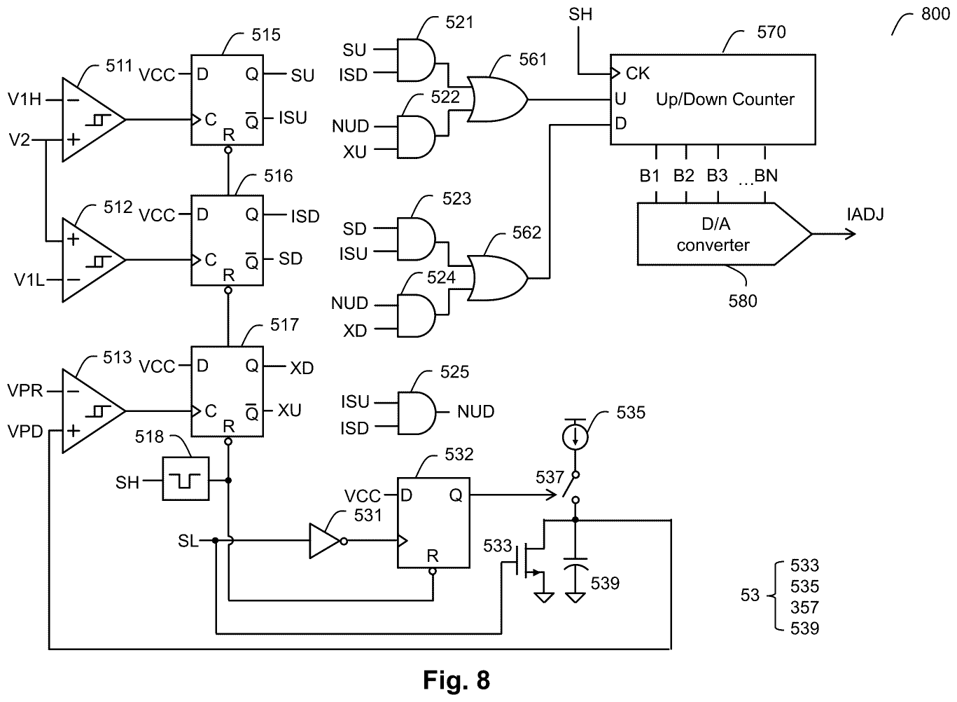

FIG. 8 illustrates a preferred adjusting circuit 800 for generating the adjustable current IADJ according to the present invention. The time-to-voltage circuit 53 comprises a transistor 533, a current source 535, a switch 537, and a capacitor 539, which together form a time-to-voltage circuit. This time-to-voltage circuit 53 generates an off-period signal VPD in response to the interval (i.e., off-period) from the deactivation of the low-side signal SL to the activation (the third signal S3) of the high-side signal SH. A longer period causes a higher level of the off-period signal VPD. A digital-to-analog converter 580 generates the adjustable current IADJ in accordance with the output of an up-down counter 570. Note that, in one embodiment, the off-period corresponds to the interval T6-T7 shown in FIG. 7, wherein both high-side signal SH and the low-side signal SL are off during the off-period.

An event when the level of the second signal V2 falls below the voltage threshold V1L initiates a down-count in the up-down counter 570, consequently decreasing IADJ and increasing the pulse width of the low-side signal SL, thereby enhancing the circulating current. Conversely, if the level of the second signal V2 exceeds the voltage threshold V1H, an up-count is triggered in the up-down counter 570, increasing IADJ and thereby decreasing the pulse width of the low-side signal SL, which reduces the circulating current.

If the level of the second signal V2 is between the voltage thresholds V1L and V1H, the adjust current IADJ varies in response to the level of the off-period signal VPD. The level of off-period signal VPD, which is proportional to the period T6-T7, influences the actions of the counter. When the level of off-period signal VPD exceeds a period reference signal VPR, it triggers a down-count in the up-down counter 570, reducing IADJ and increasing the pulse width of the low-side signal SL. Conversely, if the level of VPD falls below the period reference signal VPR, it causes an up-count, which increases IADJ and reduces the pulse width of the low-side signal SL, thereby decreasing the circulating current.

As a short summary, in one embodiment, the off-period is regulated to be equal to a predetermined target period by adjusting the pulse width of the low-side signal SL. In one embodiment, the level of the off-period signal VPD, generated based on the off-period, is regulated to be aligned with a level of the period reference signal VPR by adjusting the pulse width of the low-side signal SL, thereby aligning the off-period with the predetermined target period.

By optimizing the circulating current generated by the low-side transistor 40, zero-voltage switching (ZVS) for the high-side transistor 30 can be achieved, without incurring additional power loss due to improper (e.g., too large) negative circulating current.

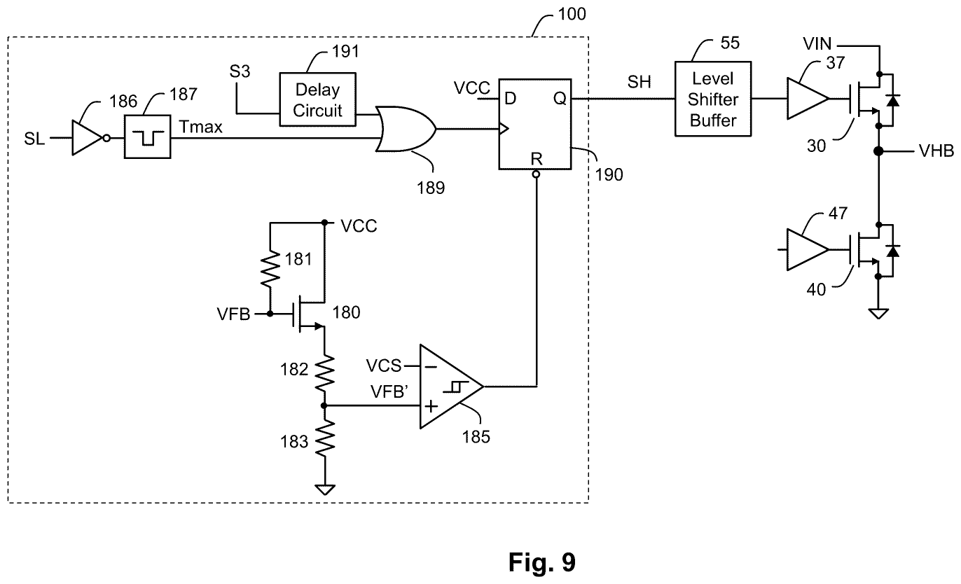

FIG. 9 illustrates another preferred circuit for generating the low-side signal and the half-bridge circuit according to the present invention. This embodiment shown in FIG. 9 is similar to that of FIG. 4, with differences in that a delay circuit 191 is further configured to provide a delay time once the level of the second signal S2 exceeds the voltage threshold (V1L). Specifically, in this embodiment shown in FIG. 9, the delay circuit 191 delays the third signal S3 to activate the high-side transistor 30.

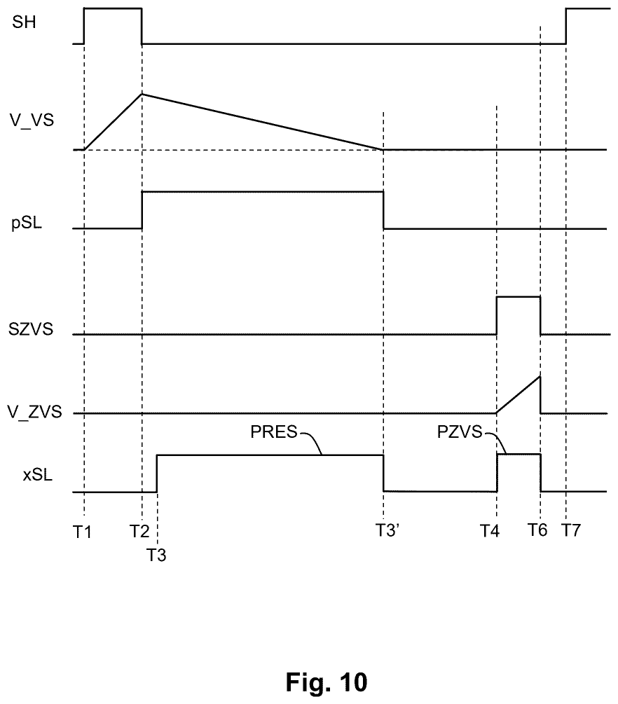

FIG. 10 depicts waveforms operating in DCM according to an embodiment of the present invention. The aforementioned automatic tuning of the pulse width of the low-side signal SL for achieving ZVS can also be applied in discontinuous conduction mode (DCM). As shown in FIG. 10, during DCM, the low-side signal SL includes 2 pulses: resonant pulse PRES and ZVS pulse PZVS. The triggering of the ZVS can be implemented by various ways in this art. In this embodiment, after the ZVS pulse PZVS is triggered, the width of the ZVS pulse PZVS can be adjusted according the previous embodiments, for achieving ZVS while keeping the circulating current sufficiently low.

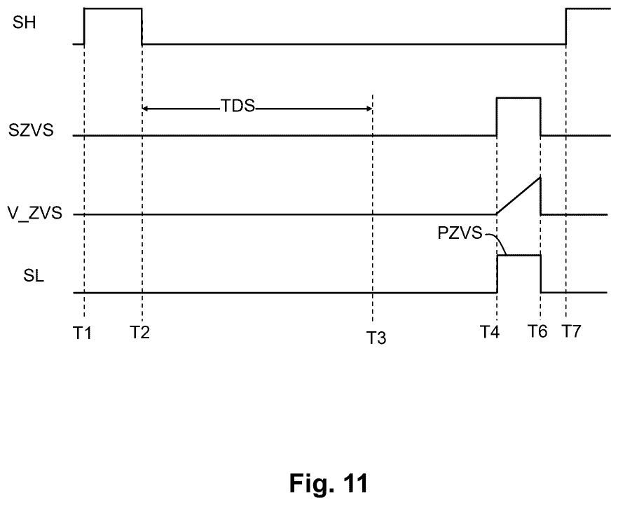

FIG. 11 depicts waveforms operating in asynchronous DCM according to an embodiment of the present invention. The aforementioned automatic tuning of the pulse width of the low-side signal SL for achieving ZVS can also be applied in asynchronous DCM. As shown in FIG. 11, in the asynchronous DCM, the low-side signal SL includes only the ZVS pulse PZVS and keep off during the demagnetization period TDS. The demagnetizing current during the demagnetization period TDS flows through the body diode of the low-side transistor 40. The triggering of the ZVS and the width of the ZVS pulse PZVS can be referred to the operation described previously for DCM.

It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A control circuit for controlling a resonant flyback power converter, comprising:
a high-side signal to control a high-side transistor;
a low-side signal to control a low-side transistor;
a negative current signal generated by an auxiliary winding of a transformer, wherein the negative current signal is related to a cross-voltage of the auxiliary winding;
a first signal generated by the negative current signal in response to the activation of the high-side transistor;
a second signal generated by the negative current signal in response to the deactivation of the low-side transistor when the high-side transistor is off; and
a third signal generated by comparing the second signal with a voltage threshold, wherein the voltage threshold is related to the level of the first signal;
wherein through a resonant capacitor, the high-side and low-side transistors are configured to switch a primary winding of the transformer, generating an output voltage through a secondary winding of the transformer;
wherein a pulse width of the low-side signal is adjusted based on the third signal to achieve zero voltage switching (ZVS) of the high-side transistor.

2. The control circuit of claim 1, wherein the high-side signal activates the high-side transistor through a level-shift buffer once the level of the second signal exceeds the voltage threshold.

3. The control circuit of claim 1, further comprising:
a sample-hold circuit configured to generate the first signal by sampling a I-to-V signal;
wherein the I-to-V signal is generated by the negative current signal;
wherein the level of the first signal correlates with an input voltage level of the transformer.

4. The control circuit of claim 1, further comprising:
an up-down counter to adjust the pulse width of the low-side signal based on the first signal and the second signal.

5. The control circuit of claim 1, wherein the control circuit is further configured to regulate an off-period to be equal to a predetermined target period by adjusting the pulse width of the low-side signal;
wherein the off-period is a duration from the deactivation of the low-side signal to a subsequent activation of the high-side signal.

6. The control circuit of claim 5, further comprising:
a period reference signal generated based on the predetermined target period; and
an off-period signal generated based on the off-period;
wherein a level of the off-period signal is regulated to be aligned with a level of the period reference signal by adjusting the pulse width of the low-side signal, thereby aligning the off-period with the predetermined target period.

7. The control circuit of claim 5, wherein when the off-period is determined to be longer than the predetermined target period, the pulse width of the low-side signal is increased, and when the off-period is determined to be shorter than the predetermined target period, the pulse width of the low-side signal is decreased.

8. The control circuit of claim 5, wherein the voltage threshold includes an upper threshold and a lower threshold;
wherein the off-period is regulated only when the second signal is between the upper threshold and the lower threshold.

9. The control circuit of claim 5, wherein the predetermined target period correlates with an optimized circulating current generated by the low-side transistor, such that the cross-voltage of the high-side transistor is sufficiently low for ZVS while the circulating current remains sufficiently low to achieve a target conversion efficiency.

10. The control circuit of claim 5, further comprising:
a maximum off-period signal to limit the off-period no longer than a corresponding maximum off-period.

11. The control circuit of claim 1, wherein the active period of the low-side signal equals or exceeds a demagnetization time of the transformer.

12. The control circuit of claim 1, further comprising:
a volt-second circuit to generate the low-side signal based on the active time of the high-side signal, an input voltage level of the transformer, and the output voltage level of the converter.

13. The control circuit of claim 1, wherein activating the low-side transistor generates a circulating current following the demagnetization of the transformer, wherein the circulating current is configured to achieve ZVS of the high-side transistor, and is constituted by a negative magnetizing current of the transformer.

14. The control circuit of claim 1, wherein when the level of the second signal is lower than the voltage threshold, the pulse width of the low-side signal is increased; wherein when the level of the second signal is higher than the voltage threshold, the pulse width of the low-side signal is decreased.

15. The control circuit of claim 14, wherein the voltage threshold includes an upper threshold and a lower threshold, wherein the upper threshold is higher than the lower threshold;
wherein when the level of the second signal is lower than the lower threshold, the pulse width of the low-side signal is increased;
wherein when the level of the second signal is higher than the upper threshold, the pulse width of the low-side signal is decreased.

16. The control circuit of claim 2, further comprising a delay circuit configured to activate the high-side transistor through the level-shift buffer only after providing a delay time once the level of the second signal exceeds the voltage threshold.

17. A control circuit for controlling a resonant flyback power converter, comprising:
a high-side signal to control a high-side transistor; and
a low-side signal to control a low-side transistor;
wherein through a resonant capacitor, the high-side and low-side transistors are configured to switch a primary winding of the transformer, generating an output voltage through a secondary winding of the transformer;
wherein an off-period is regulated to be equal to a predetermined target period by adjusting a pulse width of the low-side signal to achieve zero voltage switching (ZVS) of the high-side transistor;
wherein the off-period is a duration from the deactivation of the low-side signal to a subsequent activation of the high-side signal.

18. The control circuit of claim 17, further comprising:
a period reference signal generated based on the predetermined target period; and
an off-period signal generated based on the off-period;
wherein a level of the off-period signal is regulated to be aligned with a level of the period reference signal by adjusting the pulse width of the low-side signal, thereby aligning the off-period with the predetermined target period.

19. A control method for controlling a resonant flyback power converter, comprising:
generating a high-side signal to control a high-side transistor;
generating a low-side signal to control a low-side transistor;
generating a negative current signal related to a voltage across an auxiliary winding of a transformer;
generating a threshold generated by the negative current signal in response to the activation of the high-side transistor;
after deactivation of the low-side transistor, activating the high-side signal once the negative current signal exceeds the threshold;
switching a primary winding of the transformer through a resonant capacitor by the high-side transistor and the low-side transistor, thereby generating an output voltage through a secondary winding of the transformer; and
adjusting a pulse width of the low-side signal to achieve zero voltage switching (ZVS) of subsequent activation of the high-side transistor according to a comparison between the negative current signal and the threshold.

20. The control method of claim 19, further comprising:
regulating an off-period to be equal to a predetermined target period by adjusting the pulse width of the low-side signal;
wherein the off-period is a duration from the deactivation of the low-side signal to a subsequent activation of the high-side signal.

21. The control method of claim 20, wherein the voltage threshold includes an upper threshold and a lower threshold;
wherein the step of regulating the off-period further includes: regulating the off-period only when the second signal is between the upper threshold and the lower threshold.

22. The control method of claim 20, wherein the step of regulating the off-period further includes: configure the predetermined target period to be correlated with an optimized circulating current generated by the low-side transistor, such that the cross-voltage of the high-side transistor is sufficiently low for ZVS while the circulating current remains sufficiently low to achieve a target conversion efficiency.

23. The control method of claim 20, further comprising: limiting the off-period no longer than a maximum off-period.

24. The control method of claim 19, wherein the active period of the low-side signal equals or exceeds a demagnetization time of the transformer.

25. A control method for a resonant flyback power converter, comprising:
generating a high-side signal to control a high-side transistor;
generating a low-side signal to control a low-side transistor;
switching a primary winding of the transformer through a resonant capacitor by the high-side transistor and the low-side transistor, thereby generating an output voltage through a secondary winding of the transformer; and
regulating an off-period to be equal to a predetermined target period by adjusting a pulse width of the low-side signal to achieve zero voltage switching (ZVS) of the high-side transistor;
wherein the off-period is a duration from the deactivation of the low-side signal to a subsequent activation of the high-side signal.

26. The control method of claim 25, further comprising:
generating a period reference signal based on n the predetermined target period;
generating an off-period signal generated based on the off-period; and
regulating a level of the off-period signal to be aligned with a level of the period reference signal by adjusting the pulse width of the low-side signal, thereby aligning the off-period with the predetermined target period.
